(19) United States
(12) Patent Application Publication
(10) Pub. No.: US 2015/0079242 A1
(43) Pub. Date: Mar. 19, 2015

(54) Decorative Toothpick Mold

(71) Applicant: Traci Jones, St. Louis, MO (US)

(72) Inventor: Traci Jones, St. Louis, MO (US)

(21) Appl. No.: 14/550,326

(22) Filed: Nov. 21, 2014

Related U.S. Application Data
(63) Continuation-in-part of application No. 13/490,503, filed on Jun. 7, 2012, now abandoned.
(60) Provisional application No. 61/500,891, filed on Jun. 24, 2011.

(51) Int. Cl. A61C 15/02; A23G 3/56

(52) U.S. Cl. CPC A61C 15/02; A23G 3/563
USPC 426/134

(57) ABSTRACT

An architecture is presented that provides a decorative toothpick device designed primarily for use with chocolate-covered strawberries, cupcakes, cake pops, pastries, or other food articles. The decorative toothpick device comprises a toothpick comprising a first end and a second end, and a decorative molded topper horizontally secured to the first end of the toothpick. The decorative molded topper also comprises an image secured to a surface of the decorative molded topper. The second end of the toothpick is then inserted horizontally into a confection. The decorative toothpick device would then act as an edible decoration attached to the food article. The decorative toothpick device can come in a ready-to-use package, or be prepared by hand by a user. Furthermore, the images of the decorative molded toppers can be decorated in a variety of designs and themes, depending on the occasion.

### CROSS-REFERENCE

This application is a continuation-in-part of Utility patent application Ser. No. 13/490,503 filed Jun. 7, 2012.

### BACKGROUND

Chocolate-covered strawberries and other confections are a popular and delicious treat that can be made as a snack or as a gift. These confections can be rather plain, and users typically want to add decorations to celebrate different occasions and holidays. Some individuals may choose to purchase plastic toppers and place them on top of the strawberry or other confection, but these toppers are inedible and do not blend in very well with the colorful strawberry and chocolate, or other confection. Consequently, an effective solution is necessary.

There is a need for an edible decoration attached to a chocolate-covered (or any other covering/coating) strawberries or other confections. The present invention discloses a decorative toothpick device that is an edible decoration for chocolate-covered strawberries or other fruits, and can also be used for caramel apples, cupcakes, cake pops and other confections and finger foods. The decorative toothpick device can come in a variety of themes to suit different occasions, such as weddings, birthdays, graduations, and seasonal holidays. By using this invention, users can add a fun and decorative flair to an otherwise plain yet popular treat. All users will appreciate the appeal that this invention affords.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a decorative toothpick device designed primarily for use with chocolate-covered strawberries or other fruits, caramel apples, cupcakes, cake pops, or other confections or finger foods. The decorative toothpick device comprises a toothpick comprising a first end and a second end, and a decorative molded topper secured horizontally to the first end of the toothpick. The second end of the toothpick is then inserted horizontally into a side of the confection or finger food till the decorative molded topper contacts the confection or finger food (i.e., food article). The decorative molded topper would then be secured to the side of the food article via the toothpick. The decorative toothpick device can come in a ready-to-use package, or be prepared by hand by a user.

Furthermore in the preferred embodiment of the present invention, the decorative molded toppers are shaped as a flattened disk, square, or rectangle and then an image is secured to a surface of the decorative molded topper. The image can be a picture or a three-dimensional object. The decorative molded toppers can be decorated in a variety of designs and themes, depending on the occasion. Furthermore, any kind of additional additive can be added to the decorative molded toppers, such as sprinkles, colored edible paint, frosting, candies, etc., or any other suitable additive as is known in the art can be used to decorate the decorative molded toppers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a decorative toothpick device in accordance with the disclosed architecture.

FIG. 2 illustrates a perspective view of the decorative toothpick device inserted into a cake pop in accordance with the disclosed architecture.

FIG. 3 illustrates a perspective view of the decorative toothpick device showing the decorative molded topper without an image in accordance with the disclosed architecture.

FIG. 4 illustrates a perspective view of the decorative toothpick device inserted into an apple, wherein the image is a piano in accordance with the disclosed architecture.

FIG. 5 illustrates a perspective view of the decorative toothpick device inserted into a plurality of cake pops, wherein the image is a plurality of pictures in accordance with the disclosed architecture.

FIG. 6 illustrates a perspective view of the decorative toothpick device inserted into a cupcake in accordance with the disclosed architecture.

FIG. 7 illustrates a perspective view of the decorative toothpick device inserted into a strawberry in accordance with the disclosed architecture.

FIG. 8 illustrates a perspective view of the decorative toothpick device inserted into a cake pop in accordance with the disclosed architecture.

FIG. 9 illustrates a perspective view of the decorative toothpick device, wherein the image is a plurality of arms, legs, and a head in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a decorative toothpick device that is an edible decoration for chocolate-covered strawberries or other fruit, and can also be used for caramel apples, cupcakes, cake pops, and other confections or finger food. The disclosed invention provides individuals with a small, edible decoration that can be customized for any specific holiday, party, theme, etc., and attached to a food article (e.g., a cake pop). The decorative toothpick device comprises a toothpick, and an edible, decorative molded topper secured horizontally to an end of the toothpick. The opposite end of the toothpick is then inserted horizontally into a chocolate-covered strawberry or other fruit, or other confection or food article. The decorative toothpick device would then act as an edible decoration attached to the food article.

The decorative toothpick device can come in a variety of themes to suit different occasions, such as weddings, birthdays, graduations, seasonal holidays, etc. Additionally, the decorative toothpick device can come in a ready-to-use package, or be prepared by hand by a user. By using this invention, users can add a fun and decorative flair to an otherwise plain yet popular treat.

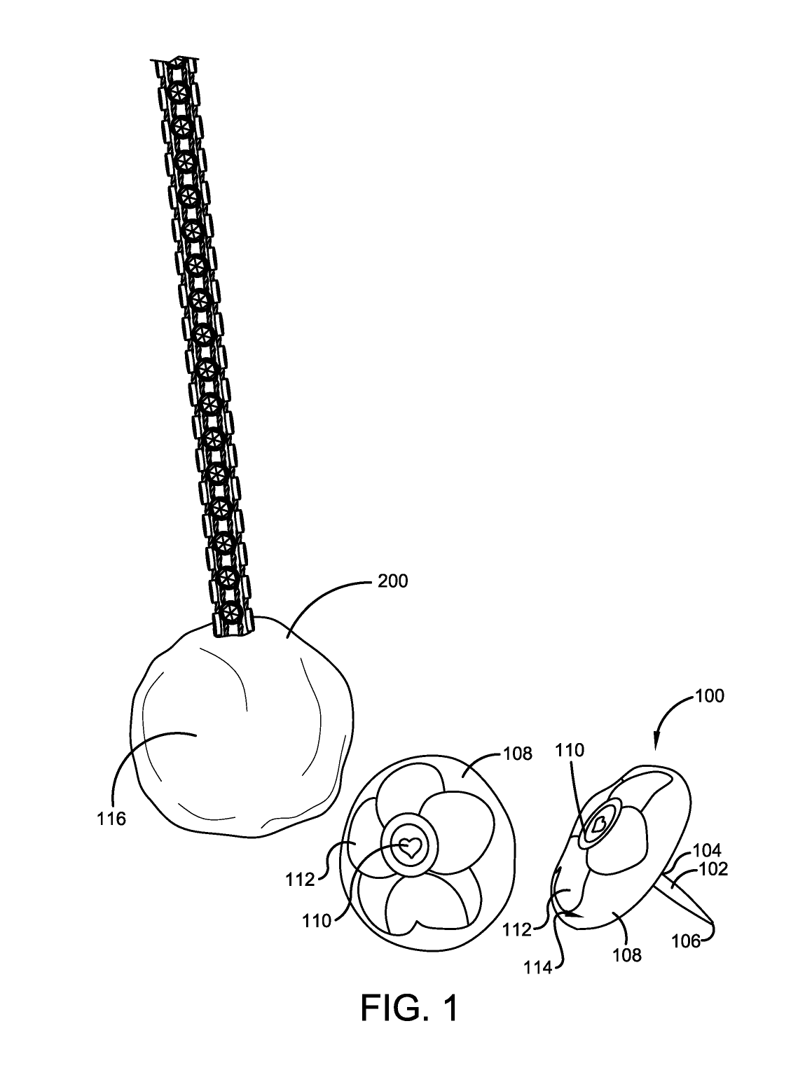

Referring initially to the drawings, FIGS. 1-3 illustrate a decorative toothpick device 100 designed primarily for use with chocolate-covered strawberries or other fruit, caramel apples, cupcakes, cake pops, or other confections or food articles. The decorative toothpick device 100 comprises an elongated member or a toothpick 102 comprising a first end 104 and a second end 106. If a toothpick is used, the toothpick 102 would have the appearance of a typically constructed toothpick as is known in the art. Typically, the toothpick 102 is cylindrical in shape, however any other suitable shape can be used as is known in the art without affecting the overall concept of the invention. The elongated member or toothpick 102 would generally be constructed of wood or plastic, though any other suitable material may be used to manufacture the elongated member or toothpick 102 as is known in the art without affecting the overall concept of the invention. The elongated member or toothpick 102 is approximately between 1 and 4 inches in length as measured from first end 104 to second end 106, and approximately between 1/16^{th} and 3/16^{th} of an inch in diameter. Further, the whole toothpick 102 is not needed and the decorative toothpick device 100 can be made with half of a toothpick 102 or even a smaller portion of the toothpick 102.

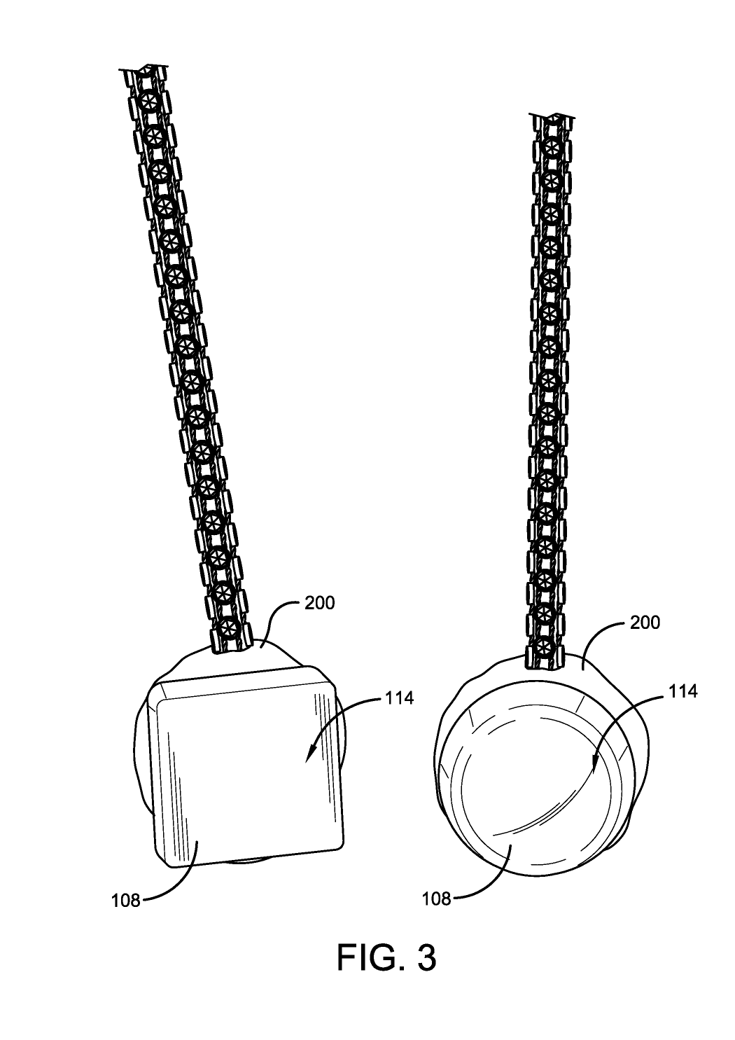

The decorative toothpick device 100 further comprises an edible, decorative molded topper 108 horizontally secured to the first end 104 of the toothpick 102. The decorative molded topper 108 can be comprised of chocolate, candy, caramel, or any other suitable, edible material that can be poured into a mold and solidified. Typically, the toothpick 102 is placed in a food-grade mold that is designed for use at elevated temperatures or with heated liquids. The decorative molded topper 108 is typically shaped as a flattened disk, square, or rectangle, or any other suitable shape (as shown in FIG. 3).

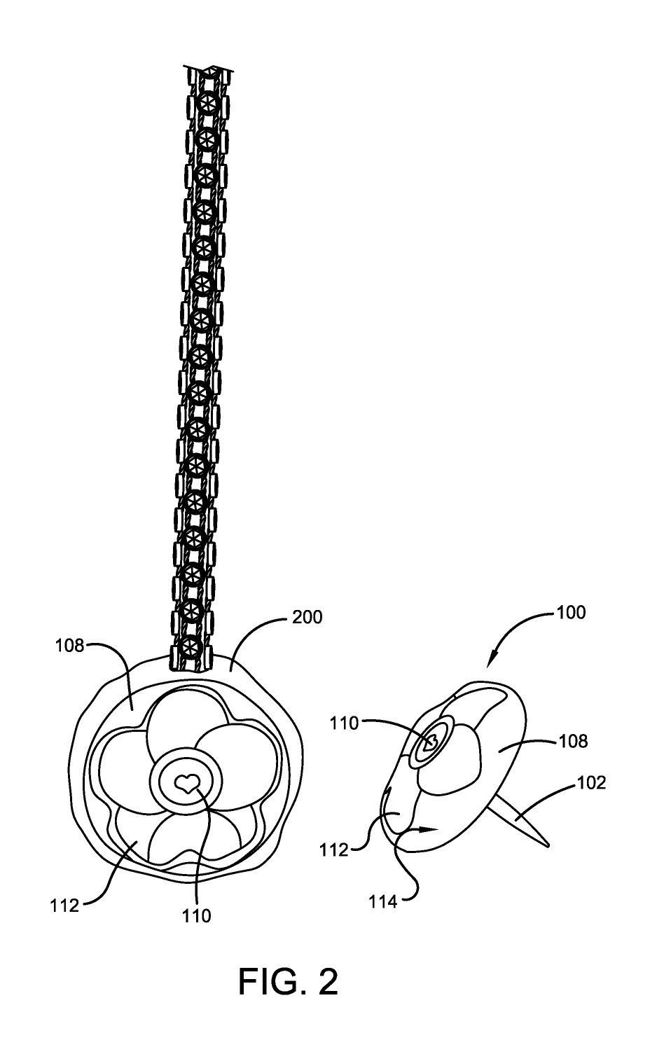

The decorative molded topper 108 then comprises an image 112 secured to a surface 114 of the decorative molded topper 108 (as shown in FIG. 2). The image 112 can be created directly on the surface 114 of the decorative molded topper 108, or the image 112 can be created independently and then can be secured to the surface 114 via any suitable means as is known in the art. The image 112 can be a picture or a three-dimensional object, or any other design as is known in the art, and the image 112 can be designed in a variety of themes to suit different occasions and celebrations, such as weddings, birthdays, showers, holidays, graduations, etc.

The decorative molded toppers 108 can then be further decorated depending on the occasion. For example, any kind of additional additive 110 can be added to the decorative molded toppers 108, such as luster dust, edible glitter, edible decorations, sprinkles, colored edible paint, frosting, candies, edible picture images, etc., or any other suitable additive as is known in the art can be used without affecting the overall concept of the invention.

FIG. 2 illustrates the decorative toothpick device 100 inserted into a cake pop 200. Specifically, the second end 106 of the toothpick 102 is inserted horizontally into the side 116 of the cake pop 200, fruit or other confection or food article till the decorative molded topper 108 contacts the food article (i.e., cake pop 200), such that the decorative molded topper 108 is secured to the side of the food article (cake pop 200) via the toothpick 102 and displays an image 112. The decorative toothpick device 100 would then act as an edible decoration attached to the food article. The decorative toothpick device 100 can be offered in a variety of designs and themes, and can come in a ready-to-use package, or be prepared by hand by a user.

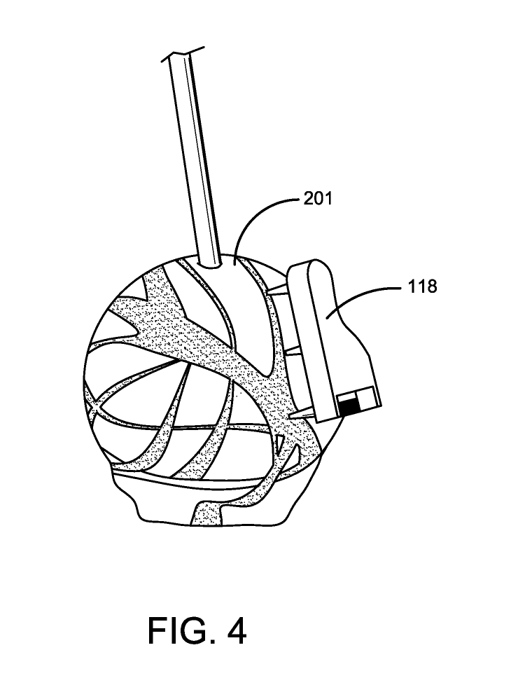

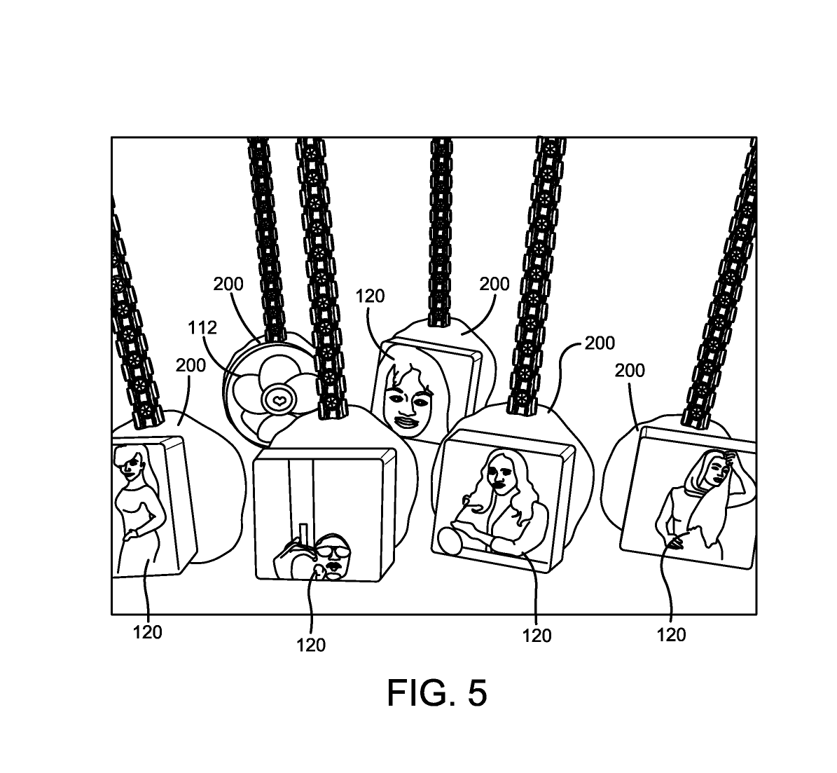

FIGS. 4-5 illustrate the decorative toothpick device inserted into apples and cake pops and decorated in various designs or themes. For example, FIG. 4 discloses the decorative toothpick device 100 inserted into a side 116 of an apple 201, wherein the image is a three-dimensional object (i.e., a piano 118). FIG. 5 discloses a plurality of decorative toothpick devices 100 each inserted into a side 116 of a plurality of cake pops 200, wherein the images 112 secured to the decorative molded toppers 108 are a plurality of pictures 120. These pictures are completely edible images, created on a frosting sheet (i.e., much like a photo printer) and then decorated with edible ink and other edible additives, these are then applied to the chocolate square (decorative molded topper 108).

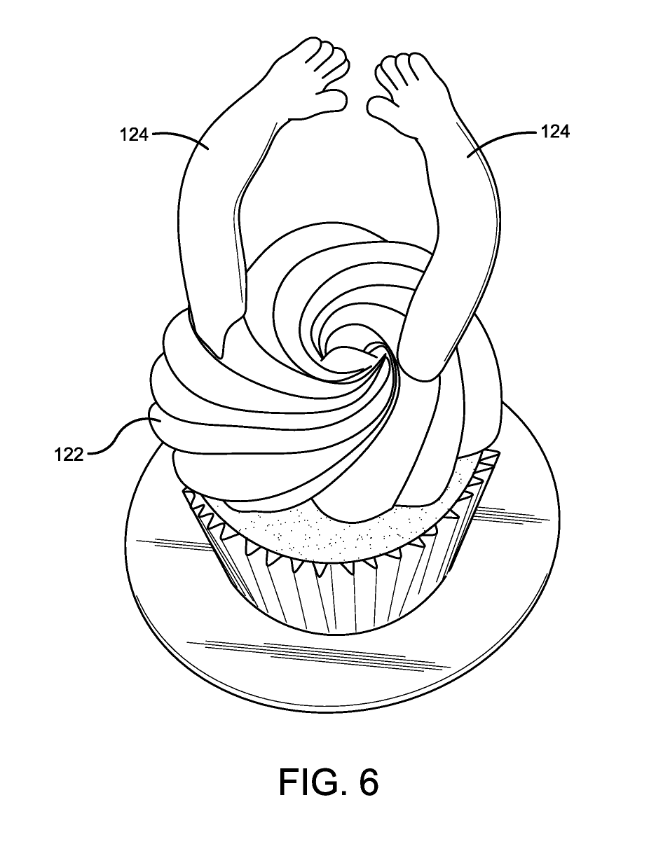

Additionally, FIG. 6 discloses another embodiment of the decorative toothpick device 100, wherein the decorative toothpick device 100 is inserted into a cupcake 122 that is decorated with colored icing or edible paint and additional additives. Specifically, in this embodiment, the decorative molded toppers 108 are a set of raised arms 124 decorated with colored icing or edible paint of different colors. Here, a toothpick 102 is horizontally secured to each arm 124 and then secured to the cupcake 122.

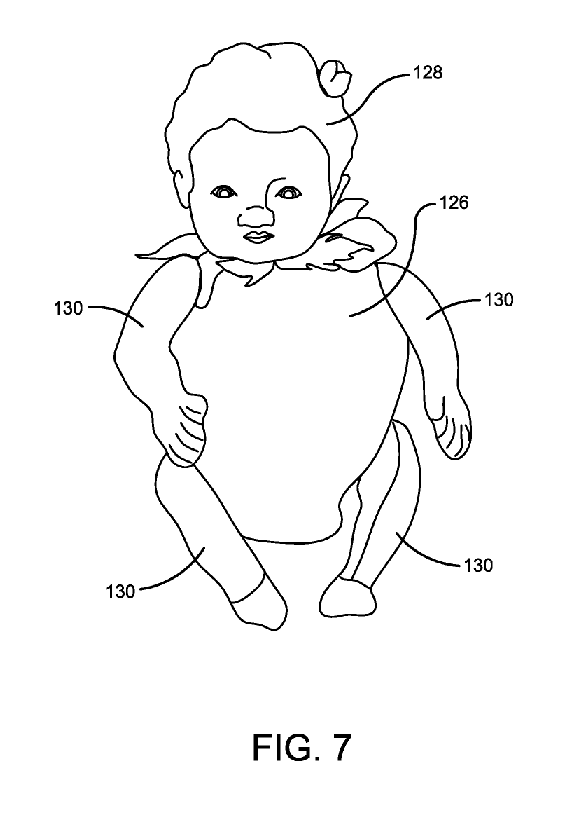

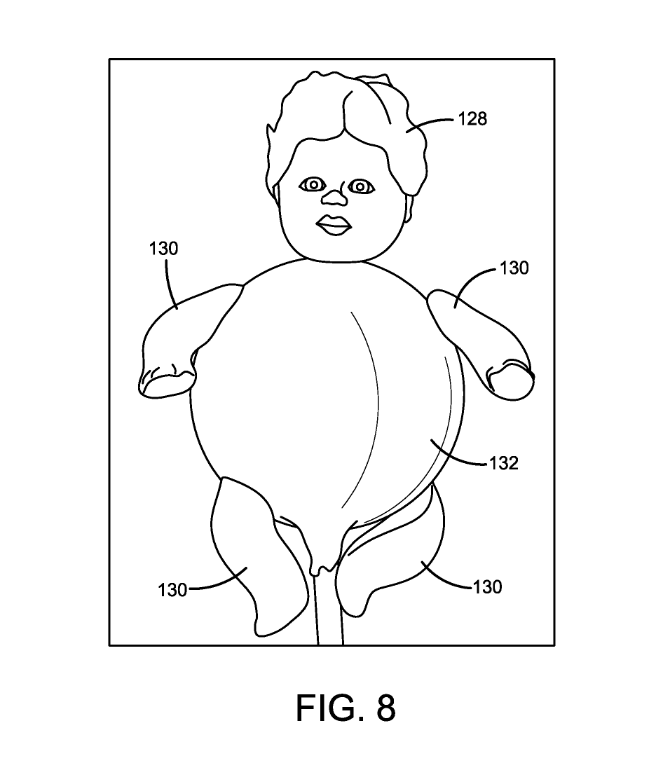

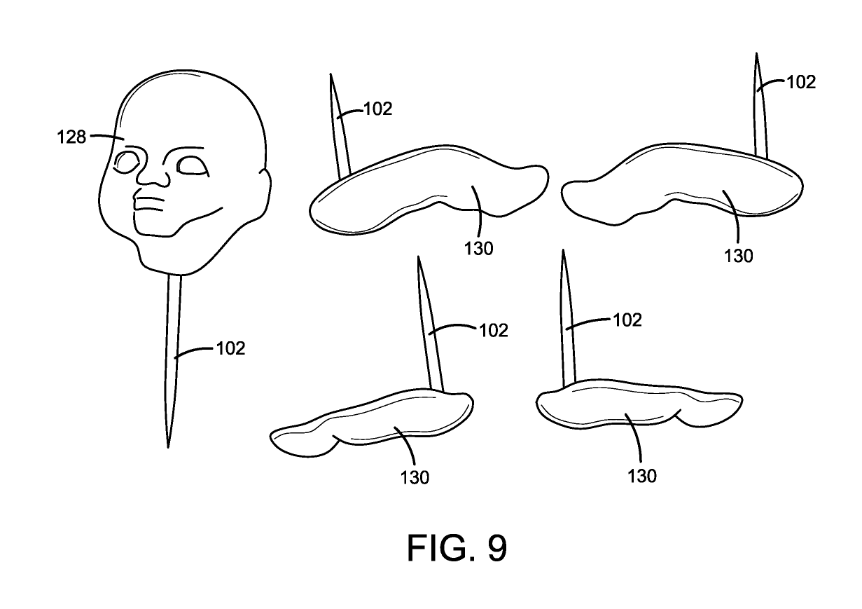

Furthermore, FIGS. 7-9 disclose another embodiment of the decorative toothpick device 100, wherein the decorative toothpick device 100 is inserted into a strawberry 126 (as shown in FIG. 7) or a cake pop 132 (as shown in FIG. 8) to resemble a baby. Specifically, a head 128 and arms and legs 130 are molded onto individual toothpicks 102 (as shown in FIG. 9) and then inserted into the food item to create the baby.

In operation, a user would purchase a specific food-grade mold that is designed for use with heated liquids or at elevated temperatures. The mold is typically shaped as a flattened disk, square, or rectangle, or any other suitable shape. Then, a user would pour hot chocolate, candy, or caramel, or other suitable, edible material into the molds. After the chocolate, candy, caramel, or other suitable, edible material hardens, the user would remove the decorative molded toppers from the molds. The molds are re-useable and can be used as often as needed. A user can then decorate the decorative molded toppers with images. The image can be created directly on the surface of the decorative molded topper, or the image can be created independently and then can be secured to the surface via any suitable means as is known in the art. The image can be a picture or a three-dimensional object, or any other design as is known in the art, and the image can be designed in a variety of themes to suit different occasions and celebrations, such as weddings, birthdays, showers, holidays, graduations, etc.

The decorative molded toppers can then be further decorated depending on the occasion. For example, any kind of additional additive can be added to the decorative molded toppers, such as luster dust, edible glitter, edible decorations, sprinkles, colored edible paint, frosting, candies, edible picture images, etc. The decorative molded toppers are then horizontally secured to the first end of the toothpick. Or, the decorative toothpick devices can come in a ready-to-use package, in which a user can purchase the decorative toothpick devices based on a specific theme or design. The user then removes the decorative toothpick devices from the packages and horizontally inserts the toothpick end of the decorative toothpick devices into a side of a cake pop, or other food article. The decorative toothpick device then acts as an edible decoration attached to the food article.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative toothpick device, comprising:
a toothpick comprising a first end and a second end; and
a decorative molded topper secured horizontally to the first end of the toothpick; and
wherein the second end of the toothpick is then inserted horizontally into a side of a food article till the decorative molded topper contacts the food article, such that the decorative molded topper is secured to the side of the food article via the toothpick and displays an image.

2. The decorative toothpick device of claim 1, wherein the decorative molded topper comprises chocolate or candy.

3. The decorative toothpick device of claim 1, wherein the decorative molded topper is shaped as a flattened disk, square, or rectangle.

4. The decorative toothpick device of claim 1, wherein the decorative molded topper comprises an edible additive.

5. The decorative toothpick device of claim 4, wherein the edible additive comprises at least one of luster dust, edible glitter, edible decorations, sprinkles, edible paint, frosting, edible picture image, or fondant.

6. The decorative toothpick device of claim 1, wherein the food article comprises at least one of a piece of fruit, a cupcake, a cookie, a cake pop, or a pastry.

7. The decorative toothpick device of claim 1, wherein the toothpick is approximately between 1 and 4 inches in length.

8. The decorative toothpick device of claim 1, wherein the decorative molded topper further comprises an image secured to a surface of the decorative molded topper.

9. The decorative toothpick device of claim 8, wherein the image is created directly on the surface of the decorative molded topper.

10. The decorative toothpick device of claim 8, wherein the image is created independently and then secured to the surface of the decorative molded topper.

11. A decorative handle device for a food article, comprising:
a toothpick comprising a first end and a second end; and
a decorative molded topper secured horizontally to the first end of the toothpick; and
wherein the second end of the toothpick is then inserted horizontally into a side of a food article till the decorative molded topper contacts the food article, such that the decorative molded topper is secured to the side of the food article via the toothpick and displays an image; and
wherein the decorative molded topper is shaped as a flattened disk, square, or rectangle and the image is secured to a surface of the decorative molded topper.

12. The decorative toothpick device of claim 11, wherein the decorative molded topper comprises chocolate or candy.

13. The decorative toothpick device of claim 11, wherein the decorative molded topper comprises an edible additive.

14. The decorative toothpick device of claim 13, wherein the edible additive comprises at least one of luster dust, edible glitter, edible decorations, sprinkles, edible paint, frosting, edible picture image, or fondant.

15. The decorative toothpick device of claim 11, wherein the food article comprises at least one of a piece of fruit, a cupcake, a cookie, a cake pop, or a pastry.

16. The decorative toothpick device of claim 11, wherein the image is a picture.

17. The decorative toothpick device of claim 11, wherein the image is a three-dimensional object.

18. A decorative toothpick device, comprising:
a toothpick comprising a first end and a second end; and
a decorative molded topper secured horizontally to the first end of the toothpick; and
wherein the second end of the toothpick is then inserted horizontally into a side of a food article till the decorative molded topper contacts the food article, such that the decorative molded topper is secured to the side of the food article via the toothpick and displays an image; and
wherein the decorative molded topper is shaped as a flattened disk, square, or rectangle and the image is secured to a surface of the decorative molded topper; and
wherein the image is a three-dimensional object.

19. The decorative toothpick device of claim 18, wherein the decorative molded topper comprises an edible additive.

20. The decorative toothpick device of claim 19, wherein the edible additive comprises at least one of luster dust, edible glitter, edible decorations, sprinkles, edible paint, frosting, edible picture image, or fondant.
